(19) United States
(12) Patent Application Publication
(10) Pub. No.: US 2024/0009700 A1
(43) Pub. Date: Jan. 11, 2024

(54) PROCESS FOR PROTECTING AN ALUMINUM ALLOY PART

(71) Applicant: SAFRAN ELECTRONICS & DEFENSE, Paris (FR)

(72) Inventors: Mathieu LEROY, Moissy-Cramayel (FR); Marie SAVOYE, Moissy-Cramayel (FR); Coralie CHEVALLIER, Moissy-Cramayel (FR); Etienne NEMETH, Moissy-Cramayel (FR)

(73) Assignee: SAFRAN ELECTRONICS & DEFENSE, Paris (FR)

(21) Appl. No.: 18/255,646

(22) PCT Filed: Nov. 25, 2021
(86) PCT No.: PCT/FR2021/052092

§ 371 Date: Jun. 2, 2023

(30) Foreign Application Priority Data
Dec. 3, 2020 (FR) FR2012621

(51) Int. Cl. B05D 7/14; C25D 13/22; B05D 7/00

(52) U.S. Cl. CPC B05D 7/14; C25D 13/22; B05D 7/584; C23C 22/56

(57) ABSTRACT

Process for protecting a part comprising an aluminum-based alloy, the process comprising depositing a primer paint layer by anaphoresis over the entire part, polymerizing the primer paint layer in order to form a non-conductive polymerized primer paint layer, laser pickling, by means of a laser beam, an area of the non-conductive polymerized primer paint layer in order to form an unpainted area, trivalent chromium chemical conversion of the unpainted area in order to form a conductive protective layer and drying the part, depositing a finishing paint layer on at least a portion of the non-conductive polymerized primer paint layer, and polymerizing the finishing paint layer.

### TECHNICAL FIELD

This disclosure relates to the protection, for example against corrosion, of a part comprising an aluminum-based alloy.

### PRIOR ART

Aluminum-based alloys have the advantage of being light. However, they may be susceptible to corrosion. Also, it is known to protect parts made from aluminum-based alloys against corrosion by carrying out, for example, a chemical conversion of the surface of the part.

This chemical conversion treatment was generally carried out by contacting the part with a bath containing hexavalent chromium (or chromium VI or Cr VI). The bath may be made from a solution such as, for example, the solution commonly designated by the registered trademark Alodine® 1200S from Henkel. This chemical conversion treatment is a chromate treatment of the aluminum-based alloy during which the alloy is converted at the surface in order to precipitate therein in particular aluminum oxy-hydroxides and aluminum chromates. This treatment allows to produce a coating on the surface of the part which increases the resistance to corrosion of the part made of an aluminum-based alloy. Moreover, this coating allows to retain electrical conductivity of the coated area and to allow easy and good quality adhesion of organic paints which are generally also based on hexavalent chromium.

Moreover, in the process used, the chemical conversion is carried out over the entire part. A paint is then applied but in order to preserve areas of electrical continuity on the part, each of these areas is covered with a resist. This operation is usually carried out manually, for example by applying a protective adhesive to the areas that are to be kept free of paint.

However, in application of the REACH (acronym for “Registration, Evaluation, Authorization and Restriction of Chemicals”) regulation, the use of hexavalent chromium has been prohibited.

There is therefore a need to develop new processes allowing to dispense with the use of hexavalent chromium and also to simplify the steps of the process and/or to reduce the production costs while improving the reliability of the process.

### DISCLOSURE OF THE INVENTION

The present disclosure aims at least at partially overcoming these disadvantages.

This disclosure relates to a process for protecting a part including an aluminum-based alloy, the process including the following steps:
depositing a primer paint layer by anaphoresis over the entire part;
polymerizing the primer paint layer in order to form a non-conductive polymerized primer paint layer;
laser pickling, by means of a laser beam, an area of the non-conductive polymerized primer paint layer in order to form an unpainted area;
trivalent chromium chemical conversion of the unpainted area in order to form a conductive protective layer;
drying the part;
depositing a finishing paint layer on at least a portion of the non-conductive polymerized primer paint layer;
polymerizing the finishing paint layer.

The process for protecting aluminum alloy parts allows to obtain a treated part which is effectively protected in particular from corrosion by a coating including conductive areas (areas having undergone chemical conversion—conductive protective layer) and non-conductive areas (areas bearing the non-conductive polymerized primer paint layer). In particular, the part has, on the areas protected by the conductive protective layer, less than five pitting per dm² (square decimeter) after exposure to neutral salt spray for 168 and 144 hours, respectively for wrought and foundry alloys, according to the requirements of standard NF EN ISO 9227:2017; on the areas protected by the non-conductive polymerized primer paint layer and/or the finishing paint layer after polymerization, the part has acceptable behavior after more than 3000 hours of exposure to neutral salt spray, according to the requirements of the standard EN ISO 9227:2017. It is understood that the non-conductive polymerized primer paint layer does not undergo chemical conversion. The non-conductive polymerized primer paint layer is not altered or modified by the chemical conversion step. And, conversely, the non-conductive polymerized primer paint layer does not pollute the chemical conversion bath. Thus, the trivalent chromium chemical conversion step only takes place on the unpainted areas, that is to say the areas not protected against corrosion by the non-conductive polymerized primer paint, which were previously pickled during the laser pickling step. It is understood that the non-conductive polymerized primer paint layer is a non-conductive protective layer.

Since the areas undergoing chemical conversion are exposed by laser pickling, the manual step of applying resists is no longer required for the application of the non-conductive polymerized primer paint.

Laser pickling allows to expose the part for specific areas where it is desired to have conductive portions of the protection. It is understood that the number of unpainted areas is not limited to one. During the laser pickling step, the non-conductive polymerized primer paint layer is removed only in the areas where electrical continuity between the part and external elements is desired. In these unpainted areas, the part is therefore exposed again.

The step of trivalent chromium chemical conversion is known per se. Typically, the conditions of implementation are provided with the technical data sheets by the manufacturers of the chemical conversion baths.

By way of non-limiting example, the chromate bath may be a bath marketed under the brand name SurTec650® or Lanthane 613.3®.

After immersion in a chemical conversion and/or anaphoresis bath, the part is rinsed with demineralised water and dried.

By way of non-limiting example, the drying step may be carried out at ambient temperature under compressed air and/or in an oven at a temperature less than or equal to 60° C. (degrees Celsius). It is understood that compressed air may be used at room temperature and then the part may be put in a study at a temperature less than or equal to 60° C. until the part is dry.

The finishing paint layer is for example applied to areas of the part to improve the fluid and UV resistance of the covered areas.

By way of non-limiting example, the finishing paint may be a paint based on polyurethane and/or acrylic (example: Interthane 870/990 from the International supplier).

By way of non-limiting example, the finishing paint layer may be applied by spraying using a pneumatic gun.

By way of non-limiting example,

In some embodiments, the unpainted area may be cleaned after laser pickling.

This step allows to remove residues, for example in the form of powder, which may have been formed during the laser pickling step.

In some embodiments, the cleaning of the unpainted area may be carried out by mechanical brushing.

In some embodiments, the cleaning of the unpainted area may be assisted by ultrasound.

In some embodiments, prior to the chemical conversion, the non-conductive polymerized primer paint layer and the unpainted area may be degreased with a solvent and/or an alkaline solution.

This step allows to degrease the part when the non-conductive polymerized primer paint layer and/or the unpainted area have dirt of the “fingerprint” type which may result from successive handlings of the part during the previous steps.

It is understood that the degreasing step is not carried out using an acid solution.

By way of non-limiting example, the solvent may be ethanol or methylethyl ketone (butanone-2, also called MEK in accordance with the acronym for MethylEthylKetone).

By way of non-limiting example, the alkaline solution may be a solution marketed under the name Sococlean A3432.

In some embodiments, the non-conductive polymerized primer paint layer may have a thickness greater than or equal to 10 μm, preferably greater than or equal to 15 μm and less than or equal to 40 μm, preferably less than or equal to 30 μm.

In some embodiments, the laser pickling may be carried out by means of a YAG laser with a wavelength of 1064 nm at a frequency comprised between 10 and 200 kHz.

In some embodiments, a profile of the laser beam may be Gaussian shaped or flat topped.

A flat top laser beam profile is also referred to as a “Top Hat”.

In some embodiments, the laser beam may have a fluence greater than or equal to 4 J/cm² and the laser pickling may comprise one to four passes.

In some embodiments, the laser beam may have a fluence less than or equal to 56 J/cm² and the laser pickling may comprise one to four passes.

In some embodiments, the laser pickling may be carried out with a laser beam coverage rate greater than or equal to

20% and less than or equal to 80%.

It is understood that the coverage rate may be in one or both directions of movement of the laser beam. The values in the two directions may be different from each other.

By way of non-limiting example, the coverage rate may be equal to 50% in both directions.

### BRIEF DESCRIPTION OF THE DRAWINGS

Other features and advantages of the object of this disclosure will emerge from the following description of embodiments, given by way of non-limiting examples, with reference to the appended figures.

FIG. 1 is a flowchart showing the steps of a process for protecting a part comprising an aluminum-based alloy.

FIG. 2 is a sectional and perspective partial schematic view of a part with a non-conductive polymerized primer paint layer.

FIG. 3 is a sectional and perspective partial schematic view of the part of FIG. 2 after laser pickling.

FIG. 4 is a sectional and perspective partial schematic view of the part of FIG. 3 after chemical conversion and drying.

FIG. 5 is a sectional and perspective partial schematic view of the part of FIG. 4 after deposition of the finishing paint layer.

In all the figures, the elements in common are identified by identical reference numerals.

### DETAILED DESCRIPTION

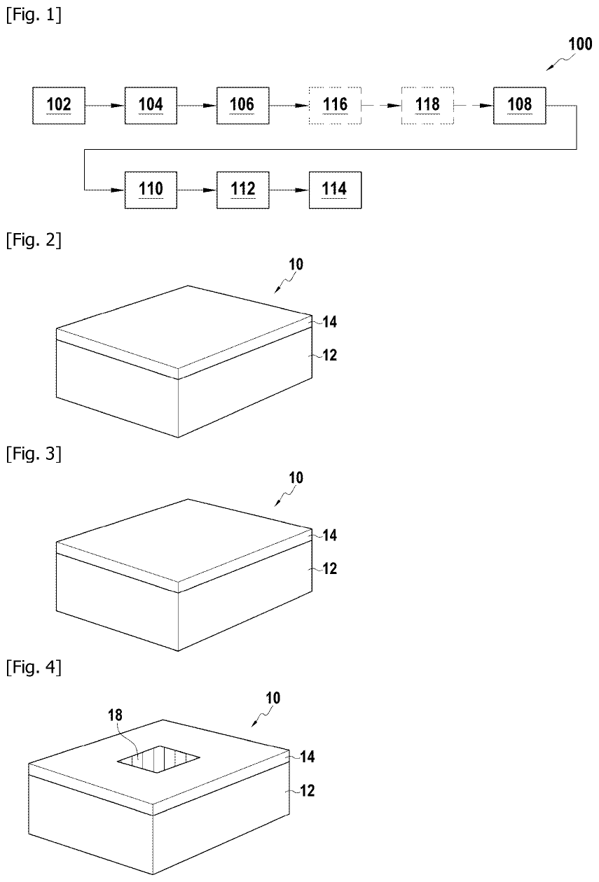

FIG. 1 represents a process 100 for protecting, in particular against corrosion, a part 12 comprising an aluminum-based alloy.

The process 100 comprises a first step of depositing 102 a primer paint layer by anaphoresis over the entire part 12. The step of depositing the primer paint layer by anaphoresis is followed by a step of polymerizing 104 the primer paint layer to obtain a non-conductive polymerized primer paint layer 14 over the entire part 12, as shown in FIG. 2.

It will be noted that FIG. 2 is a schematic partial sectional view of an element 10. It is therefore understood that the part 12 is entirely covered by the non-conductive polymerized primer paint layer 14. A partial sectional view was shown in order to see the part 12 and the non-conductive polymerized primer paint layer 14.

The step 102 of depositing the protective layer 14 is carried out by anaphoresis.

Anaphoresis is a process for forming the non-conductive polymerized primer paint layer 14 by immersing the part 12 in a bath of electrically charged paint, and which, under the effect of an electrical voltage applied between the part serving as anode and a counter-electrode, is deposited on the part 12. Once the deposit has reached the desired thickness, the deposit is polymerized at a temperature allowing to fix the paint on the part 12 and form the non-conductive polymerized primer paint layer 14. By way of non-limiting example, mention may be made of the electrodeposited paint system Aerocron 2200.

When the part 12 is entirely coated with the non-conductive polymerized primer paint layer 14, the part 12 is protected in particular against corrosion. However, this protective layer is non-conductive.

The process 100 comprises a step 106 of laser pickling, by means of a laser beam, an area of the non-conductive polymerized primer paint layer 14 in order to form an unpainted area 16, as shown in FIG. 3. It is understood that the part 12 is exposed in the unpainted area 16.

The laser pickling 106 may be carried out by means of a YAG laser with a wavelength of 1064 nm at a frequency comprised between 10 and 200 kHz.

The profile of the laser beam may be Gaussian shaped or flat topped.

As shown in FIG. 3, the part 12, from which the non-conductive polymerized primer paint layer 14 was removed in one area, has an unpainted area 16. It is understood that the number of unpainted areas 16 is not limited to one. FIG. 3 being a schematic figure, the unpainted area 16 is shown as having the shape of a square. It is understood that this shape is not limiting and that the unpainted area 16 may have any shape. The shape of the unpainted area 16 is defined by the passage of the laser beam over the non-conductive polymerized primer paint layer 14.

The process 100 comprises a step of trivalent chromium chemical conversion 108 of the unpainted area 16 in order to form a conductive protective layer 18, as shown in FIG. 4.

As schematically shown in FIG. 4, the non-conductive polymerized primer paint layer 14 is not altered or modified by the chemical conversion step 108. Thus, the trivalent chromium chemical conversion step 106 only takes place on the unpainted areas 16 which have been previously pickled during the laser pickling step 106 and the formation of the conductive protective layer 18 is formed only at the location of the unpainted areas 16.

The process 100 comprises a drying step 110. By way of non-limiting example, the drying step 110 may be carried out at ambient temperature under compressed air and/or in an oven at a temperature less than or equal to 60° C. (degree Celsius). It is understood that compressed air may be used at room temperature and then the part 12 may be put in a study at a temperature less than or equal to 60° C. until the part 12 is dry.

The process 100 comprises a step 112 of depositing a finishing paint layer on at least a portion of the non-conductive polymerized primer paint layer.

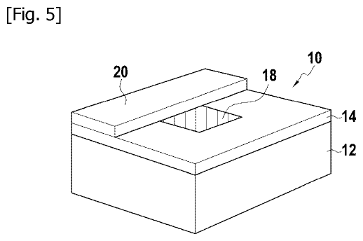

The process 100 comprises a step of polymerizing 114 the finishing paint layer in order to form a polymerized finishing paint layer 20 on the non-conductive polymerized primer paint layer 18, as shown schematically in FIG. 5.

The polymerized finishing paint layer 20 may not cover the entire non-conductive polymerized primer paint layer 18, as shown schematically in FIG. 5.

The process 100 may also comprise a step 116 of cleaning the unpainted area 16 after the laser pickling step 106.

When the unpainted area(s) 16 are covered with a light dusting due to laser pickling, it is advantageous to clean the unpainted areas 16 to remove these residues, for example in the form of powder, which may have formed during the laser pickling step 106.

The cleaning 116 of the unpainted area 16 may be carried out by mechanical brushing.

The cleaning 116 of the unpainted area 16 may be assisted by ultrasound.

The process 100 may also comprise a step 118 of degreasing the non-conductive polymerized primer paint layer 14 and the unpainted area 16 after the laser pickling step 106.

The degreasing step 118 may or may not be carried out after the cleaning step 116.

Thus, before the chemical conversion 108, the part 12 and the non-conductive polymerized primer paint layer 14 may be degreased 118 with a solvent and/or an alkaline solution.

This step allows to degrease the part when the non-conductive polymerized primer paint layer 14 and/or the unpainted area 16 having dirt of the “fingerprint” type which may result from successive handlings of the part during the previous steps.

It is understood that the degreasing step 118 is not carried out using an acid solution.

By way of non-limiting example, the solvent may be ethanol or methyl ethyl ketone (butanone-2, also called MEK in accordance with the acronym for MethylEthylKetone

By way of non-limiting example, the alkaline solution may be a solution marketed under the name Sococlean A3432.

Although the present description has been described with reference to a specific embodiment, it is obvious that various modifications and changes can be made to these examples without departing from the general scope of the invention as defined by the claims. Furthermore, individual features of the various embodiments discussed may be combined in additional embodiments. Accordingly, the description and the drawings should be considered in an illustrative rather than restrictive sense.

1. A process for protecting a part comprising an aluminum-based alloy, the process comprising the following steps:
depositing a primer paint layer by anaphoresis over the entire part;
polymerizing the primer paint layer in order to form a non-conductive polymerized primer paint layer;
laser pickling, by means of a laser beam, an area of the non-conductive polymerized primer paint layer in order to form an unpainted area;
trivalent chromium chemical conversion of the unpainted area in order to form a conductive protective layer;
drying the part;
depositing a finishing paint layer on at least a portion of the non-conductive polymerized primer paint layer;
polymerizing the finishing paint layer.

2. The process according to claim 1, wherein the unpainted area is cleaned after the laser pickling.

3. The process according to claim 2, wherein the cleaning of the unpainted area is carried out by mechanical brushing.

4. The process according to claim 2, wherein the cleaning of the unpainted area is assisted by ultrasound.

5. The process according to claim 1, wherein prior to the chemical conversion, the non-conductive polymerized primer paint layer and the unpainted area are degreased with a solvent and/or an alkaline solution.

6. The process according to claim 1, wherein the non-conductive polymerized primer paint layer has a thickness greater than or equal to 10 μm, preferably greater than or equal to 15 μm and less than or equal to 40 μm, preferably less than or equal to 30 μm.

7. The process according to claim 1, wherein the laser pickling is carried out by means of a YAG laser with a wavelength of 1064 nm at a frequency comprised between 10 and 200 kHz.

8. The process according to claim 1, wherein the profile of the laser beam is Gaussian shaped or flat topped.

9. The process according to claim 1, wherein the laser beam has a fluence greater than or equal to 4 J/cm² and the laser pickling comprises one to four passes.

10. The process according to claim 1, wherein the laser pickling is carried out with a laser beam coverage rate greater than or equal to 20% and less than or equal to 80%.
